(19) United States
(12) Patent Application Publication
(10) Pub. No.: US 2026/0365073 A1
(43) Pub. Date: Nov. 19, 2026

(54) SYSTEMS AND METHODS FOR USING ELECTRIC VEHICLES AS AN ENERGY HUB

(71) Applicant: GEORGIA TECH RESEARCH CORPORATION, Atlanta, GA (US)

(72) Inventors: Deepak M. DIVAN, Marietta, GA (US); Joseph Benzaquen SUNE, Atlanta, GA (US); Ruomu HAO, Atlanta, GA (US)

(21) Appl. No.: 19/490,739

(22) PCT Filed: Jun. 6, 2024
(86) PCT No.: PCT/US2024/032796

§ 371 Date: Dec. 5, 2025

Related U.S. Application Data
(60) Provisional application No. 63/506,530, filed on Jun. 6, 2023.

(51) Int. Cl. B60L 55/00; B60L 53/10; B60L 53/16; B60L 53/22; B60L 53/24; H02J 3/01; H02J 3/32; H02J 101/24; H02J 105/37; H02J 105/40; H02M 7/797

(52) U.S. Cl. CPC B60L 55/00; B60L 53/11; B60L 53/16; B60L 53/22; B60L 53/24; H02J 3/01; H02J 3/322; H02M 7/797; B60L 2210/10; B60L 2210/44; B60L 2240/525; B60L 2260/22; H02J 2101/24; H02J 2105/37; H02J 2105/40; H02J 2207/20

(57) ABSTRACT

A system for power delivery includes an AC voltage generated at a common port connected to an electric vehicle and provides low total harmonic distortion (THD). The common port can be connected to an electric grid operating outside the vehicle and can autonomously form or follow the grid to provide advanced grid support functionality under normal and fault conditions without requiring additional power converters for real-time coordination and control outside the vehicle.

### CROSS REFERENCE TO RELATED APPLICATIONS

This disclosure claims priority to and incorporates entirely by reference U.S. Provisional Patent Application Ser. No. 63/506,530 filed on Jun. 6, 2023, entitled Systems and Methods for Vehicle to Everything Communication Using Electric Vehicles As An Energy Hub, the disclosure of which is incorporated by reference herein.

### FIELD OF THE INVENTION

This disclosure relates to a system for using an electric vehicle battery as a power source to a load outside of the electric vehicle.

### BACKGROUND

The advent of the modern electric vehicle (EV) started in the early 1990s with the announcement of the Impact concept vehicle and the commercial release of the EV1 by General Motors. Recognizing a need to standardize EV charging requirements, the Electric Power Research Institute (EPRI), utilities, and automakers joined hands to start the Infrastructure Working Council (IWC) in 1991. The internal architecture of all EVs and the charging infrastructure for each have been based on principles set in place at that time. To minimize cost and mass onboard the vehicle, only the battery and the traction inverter were built into the car. Because it was felt that most of the EV owners would be affluent, charging was to be done at home or at work, where the car was stationary for an extended period.

Level 1 charging at 120-V was limited to 15-A and could take days to charge the battery, and was considered only an emergency option. This led to the idea of Level 2 charging at 6-12 kW using an onboard charger that could charge the EV battery overnight, and which would be the normal means to charge the battery. However, it was also understood that on occasion, the EV owner may want to make a long trip and would need to be able to charge the battery and to get some range over a shorter period of say 15-20 minutes. This required charging rates of 50-100 kW (Level 3) and resulted in chargers that were very bulky and expensive, outside of the scope of what could be located on the EV itself at that time. The idea of DC Fast Charging (DCFC) was developed that necessitated a direct connection of the EV battery to an outside converter and coordination of safe and rapid charging [1]. No one really thought that EVs would go mainstream and become the economical option.

Fast-forward 30 years to 2022, and there is a completely different scenario. Battery costs have plummeted from $1500/kWH in 2000 to $130/kWH in 2022 [2 ], with continuing decreases forecast over the next decade. Power inverters made with wide bandgap Silicon Carbide (SiC) devices can provide 150-250 kW per axle and have shrunk in size and improved in efficiency. EV range has increased, now routinely at 250-500 miles, with battery packs of 50-100 kWh. Fast charging stations can dispense 250 kW and more, with hundreds of thousands now being deployed [3]. Cost of operating EVs is well below conventional cars, and the EV market is exploding globally at 60% year-over-year [4]. A mid-level estimate of 125 million EVs in the US by 2035 shows the growth potential of EVs. It should also be noted that such an EV fleet would represent stored energy of ~9,000 GWh, more than ten times what is planned in terms of grid storage, and enough to run the US for a day. For the EV owner, 70 kWh could power their home for a week (if usage is properly rationed).

Over the last five years, the interest in using the energy stored in the EV battery to create value has been widely discussed and explored—e.g., vehicle to grid (V2G), vehicle to home (V2H), etc. [5].

However, decisions made in the 1990s in terms of system architecture and standards now limit what can cost-effectively be done. Most EV manufacturers have developed platforms based on 400 V DC batteries, and are operating inverters rated at 150-300 kW to drive their traction motors, with peak currents of ~1000 Amperes needed from the batteries. While this can be done with large cables and busbars in the vehicle, implementations would also need to supply 750 Amperes to charge it at that rate. This makes for expensive and bulky liquid-cooled charging cables that cannot easily be maneuvered and is prompting some EV manufacturers to consider 800-V batteries, requiring the development of an expensive new vehicle platform. This also leads to more diversity in the EV charger fleet, making universal access even more difficult.

### SUMMARY OF THE DISCLOSURE

In one embodiment, an electric vehicle provides bidirectional energy exchange between the battery and an external source or load, interfaced through a common port and an onboard power converter, capable of providing, on the common port, DC voltages that can be lower or greater than the battery voltage. The electric vehicle further includes standard single and three phase AC voltages, which can also be lower or greater than the battery voltage, and where the common port is isolated from the battery through a high-frequency link transformer.

In another embodiment, a system for power delivery includes an AC voltage generated at a common port connected to an electric vehicle and providing low total harmonic distortion (THD). The common port can be connected to the grid and can autonomously form or follow the grid to provide advanced grid support functionality under normal and fault conditions without requiring additional power converters for real-time coordination and control outside the vehicle.

In another embodiment, a system for power delivery connects a battery of an electric vehicle to an onboard power converter that can be extended with additional semiconductors and filter elements to provide power to a traction motor at a nominal voltage that can be higher than the battery voltage. The system is configured to further provide power along with filtered sinusoidal waveforms to allow the traction motor to be located at a distance from the onboard power converter and enables higher power through modularity and parallel connection of many converters.

In another embodiment, a system for power delivery connects a battery of an electric vehicle to an onboard power converter, and the onboard power converter can be connected via the common port to a power input device at the incoming service point (e.g., at the meter via a meter collar) for the building, and wherein the vehicle can power the building load without need for rewiring inside the house, or for additional power converters and control devices outside the vehicle.

In another embodiment, multiple onboard converters from multiple vehicles can be connected in parallel by connecting the common ports in parallel so as to increase the power and energy capacity of the combined system without requiring additional control systems, paralleling gear, or power converters. Such a collection of vehicles with onboard converters described herein, can also form ad-hoc fractal microgrids that can be rapidly deployed under resiliency conditions.

In another embodiment, an electric vehicle includes an onboard power converter that manages all requirements at the port in real-time, using slower communications with the cloud only for optimization and managing energy transactions.

In another embodiment, a system for using an electric vehicle battery as a power source to a load outside of an electric vehicle may include a high frequency transformer assembly connected to the electric vehicle battery and changing an original output power transmission of the EV battery to a different power level transmission; a three phase DC to AC converter circuit 605, 630 connected to the transformer assembly and receiving the different power level transmission to provide power to a load apparatus either on the electric vehicle or outside the electric vehicle; and a second traction converter 640 connected to the three phase DC to AC converter circuit 605, 630 and further connected to at least one traction motor 650 on the electric vehicle. The three phase DC to AC converter circuit is operable during stationary modes 645 of the electric vehicle. The second traction converter is operable during traction mode 646 of the electric vehicle.

### BRIEF DESCRIPTION OF THE FIGURES

FIG. 1 is a simplified block diagram of an EV powertrain as disclosed herein.

FIG. 2 is a schematic illustration of a typical vehicle connected to the outside world via connectivity hardware to implement target applications.

FIG. 3 is a schematic illustration of an isolated DC/DC transformer with a three-phase DC/AC converter embodiment.

FIG. 4A is a schematic illustration of a universal minimal converter topology, illustrating an on board charger (OBC) substitute.

FIG. 4B illustrates exemplary waveforms for AC voltage, AC current, and DC Current of the embodiment of FIG. 4A.

FIG. 4C illustrates a side voltage and leakage plot for the embodiment of FIG. 4A.

FIG. 5 is a schematic illustration of a typical vehicle connected to outside world connectivity devices and a few example target applications.

FIG. 6 is a schematic illustration of an example universal minimal converter topology-with motor drive integration-as disclosed herein.

### DETAILED DESCRIPTION

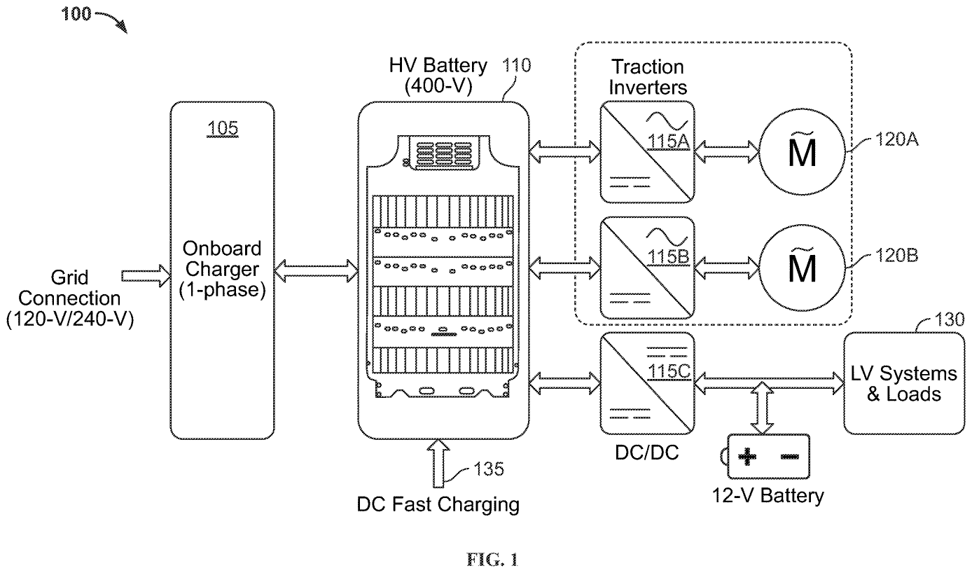

FIG. 1 shows a simplified block diagram of an EV powertrain 100 embodiment. The high-voltage battery 110 serves as the main energy source, powering the traction motors 120A, 120B and onboard loads 130 through power converters 115A, 115B, 115C. Two interfaces are available to connect the HV battery to off-board systems, including (i) the onboard charger 105 (OBC) and (ii) the DC fast charging port 135. Both of these are integrated into a single standardized vehicle connector.

To meet the desire for using the energy stored in the EV battery in other use cases, some EVs are now featuring bidirectional onboard chargers, to enable vehicle to grid (V2G) and vehicle to home (V2H) functionality, but that is limited to 12 kW or so. Other vendors are providing intermediate devices and smart control panels in houses to be able to access the energy stored in the EV battery for home resiliency [6]. Another key application is the ability to use battery energy to power loads, for instance at a work site. Some EVs, such as the Ford F-150 Lightning, offer such functionality using separate additional hardware [7].

It can be seen that there is strong interest in converting the energy stored in the EV battery into value. However, as researchers work with existing batteries and onboard chargers, additional modes or applications (other than basic Level 1 or Level 2 charging) come to light, particularly those applications that exchange energy with the battery-e.g., Level 3 DC fast charging (L3 DCFC charging), V2G, V2H, V-to-microgrid, etc. All of these applications require hardware and power conversion gear outside the vehicle, with layers of customized software to integrate with vehicle, home and grid requirements. This is a highly customized and expensive exercise and limits the economic viability of many of these applications. For instance, for V2H, the power delivered from the vehicle is limited to 10-15 kW, requiring rewiring of the home electrical panel so that designated critical loads can be supported.

Further, choices of technology that have been made result in additional constraints. For instance, access to fast charging, now the preferred mode of charging, requires a fast-charging station that can cost $50,000 to $100,000, the cost of which has to be recovered from the EVs charging there. This can dramatically increase the cost of energy used by an EV and can dramatically increase the cost of ownership for an EV. Similarly, the use of Silicon Carbide (SiC) voltage source inverters, has necessitated an integration of the inverter with the motor, to manage electromagnetic interference (EMI) and voltage reflections, with high cost and additional motor and inverter losses. This limits the ability to make the architecture more modular or to use the traction inverter for other functions, such as V2G. The high peak powers, approaching 400-kW for the case discussed above, translate into 1,000-Amp DC at the battery, and similar high currents in the traction motors. Long cables from the battery pack to the inverter at the axle incur additional costs and losses, as well as a reduction in voltage/power that can be delivered.

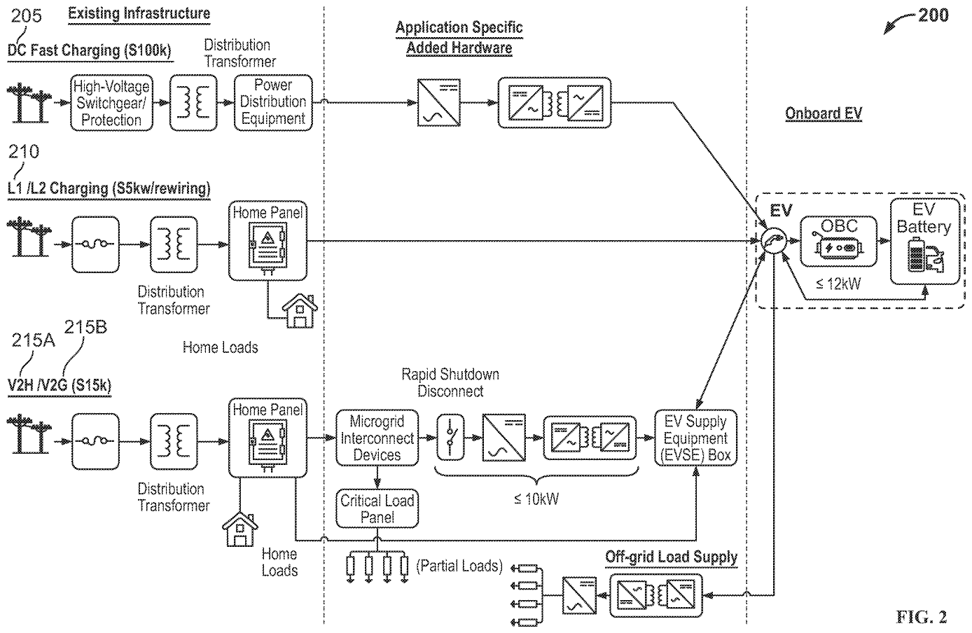

The complexity of these implementations also makes it difficult for the average EV owner/user, someone who is relatively unskilled technically, to easily use the advanced functionality. However, under the current paradigm, there is no other option but to add the outside layers of hardware, control, and software to achieve the desired functionality. FIG. 2 shows a typical “vehicle-to-outside-world” connectivity 200 and a few example target applications (i.e., DC fast charging 205, Level 1 to Level 2 (L1/L2) charging 210, V2H 215A, and V2G 215B), along with an estimate of cost for each advanced function. So, while the desired functionality is achievable in principle, the cost implications may limit broad access and economic viability. On the other hand, simply bringing all the needed hardware and software onboard the EV would also require extensive engineering, as the impact on cost, weight, size, and complexity could be unacceptable.

### EV as an Energy Hub

This disclosure tackles this problem in two steps. The first is to consider leaving the existing 400-V EV battery and traction system unchanged, and replace the onboard charger with a more advanced converter with a universal grid interface that can connect the vehicle to any DC or AC voltage, including 400 VDC, 800-VDC, 240-VAC 1-phase (including split phase 120-V), 208-V 3-phase and 480 volts AC 3-phase. This system, method, and apparatus can bi-directionally transfer a desired level of power up to a maximum of approximately 400-A (320-kW at 800-VDC or 480-VAC) between the EV and the grid/load—all with one standard cable and connector system. Intrinsic safety is maintained for the owner/operator by ensuring that the battery is isolated from the grid using a high-frequency transformer, and that all common safety requirements, such as ground fault interruption, are implemented.

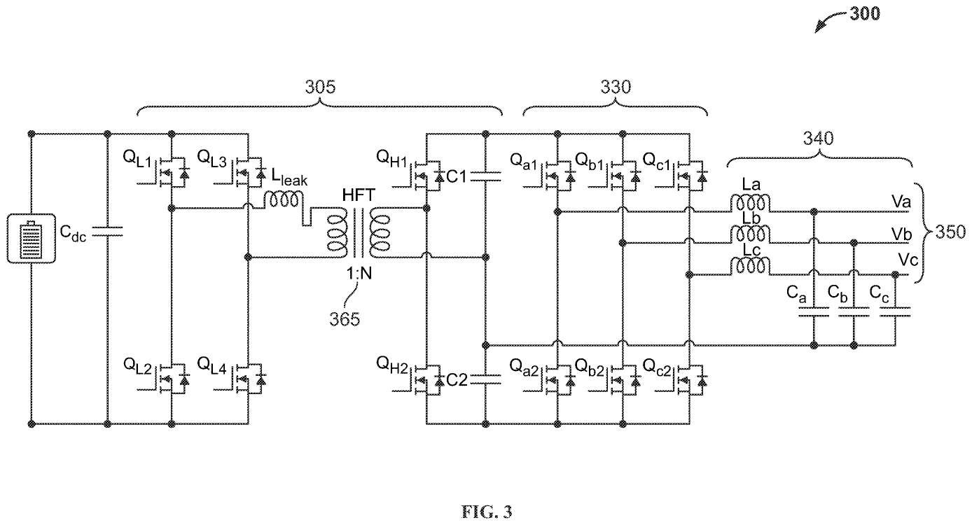

There are several approaches possible for realizing such functionality. One is shown in the power system 300 of FIG. 3 with the use of a high-frequency DC/DC converter, such as a Dual Active Bridge (DAB) converter 305, with a transformer 365 followed by a three-phase voltage source converter 330 with LC filters 340, which would then connect to the outside world with three phase connectors 350. The converter could operate in DC or AC mode and with an internal DC bus voltage of approximately 850-V and could connect with any outside voltage from 208 volts to 480 volts AC, as well as to 400 or 800 VDC. A non-limiting, example schematic of such a system is shown in FIG. 3. Other implementations have been shown by Divan et al. [8]. Such a system requires significant DC capacitors, has bulky inductive filters on the AC side, has high switching losses in the inverter stage, and is vulnerable to voltage transients on the grid. As a result, the volume and cost of such an implementation can be high, especially for an onboard application.

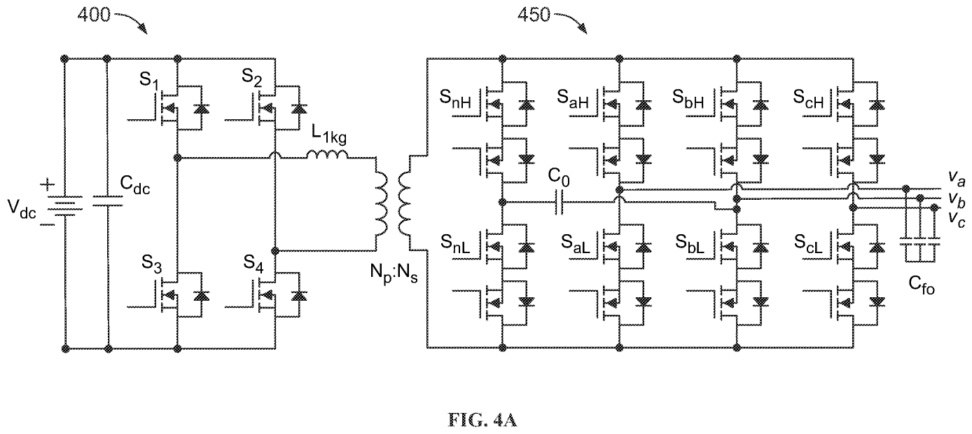

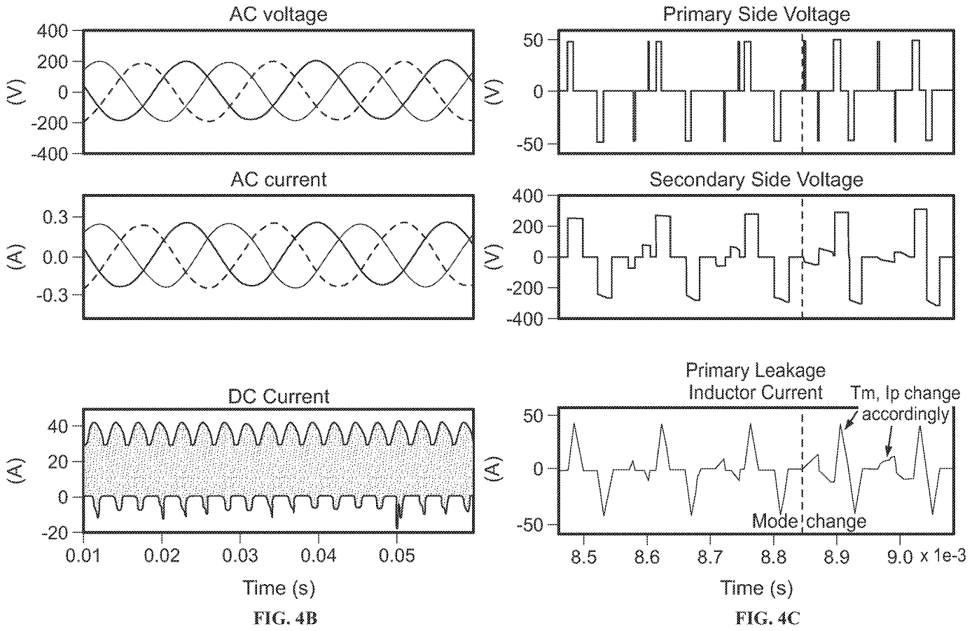

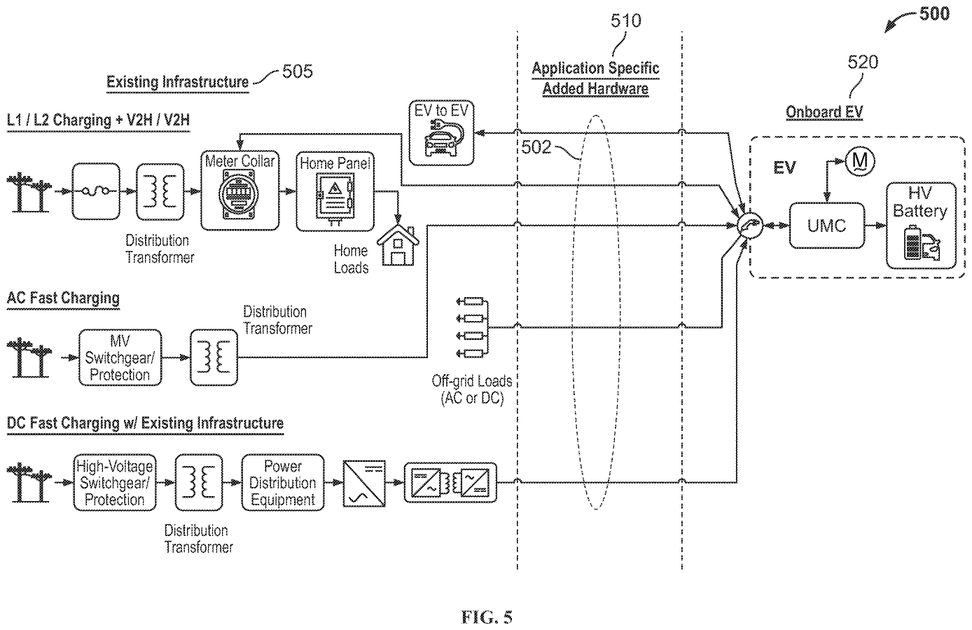

In a previous commonly owned patent disclosure, incorporated by reference as if set forth herein, (i.e., U.S. patent application Ser. No. 18/594,917 claiming priority to U.S. Prov. Pat. App. No. 63/488,134), a multimode control strategy has been disclosed for a Universal Minimal Converter (UMC) topology (e.g., shown for example in FIGS. 4A, 4B and 4C of this disclosure), which realizes high power density and low losses by the use of soft-switching for the devices, and the elimination of the inductive filters. The fully bidirectional converter 400, 450 switches at high frequency (~20 kHz) to allow the systems, methods, and apparatuses of this disclosure to realize high control bandwidth. Further, the bi-directional converter 400, 450 exhibits current source characteristics on both ports to realize advanced vehicle to grid (V2G) functions, including grid-forming, inertial support, and damping. Details of the converter operation are set forth in the U.S. patent application Ser. No. 18/594,917 incorporated by reference.

This disclosure illustrates that such embodiments can work using power-frequency droop principles (i.e., a control mode for AC power generators by which the power output of a generator reduces as the line frequency increases). These droop principles allow for an EV to autonomously share power between many connected V2G systems. As a result, it can form microgrids for resiliency applications. Embodiments of this disclosure are different from a voltage source converter, which can only work in “buck” mode where the output voltage is lower than the input voltage (i.e., lowering the voltage when input power gets closer to the high voltage threshold), because the Universal Minimal Converter (UMC) 400, 450 of FIG. 4 also allows for a boost mode where the output voltage is higher than the input voltage (i. e, increases voltages when the power is close to the low voltage threshold).

In non-limiting embodiments of this disclosure, systems, methods and apparatuses described herein can operate in buck-boost mode, providing more flexibility, controllability, and protection. It is estimated that a liquid-cooled 320-kW UMC converter, including power devices and all filter elements, can fit into a 24″×12″×6″ package for a power density of 300-kW/cu. ft and achieve an efficiency of ~99%. Herein, high power density can be achieved by packaging the UMC semiconductors in a compact module with the appropriate die/thermal designs.

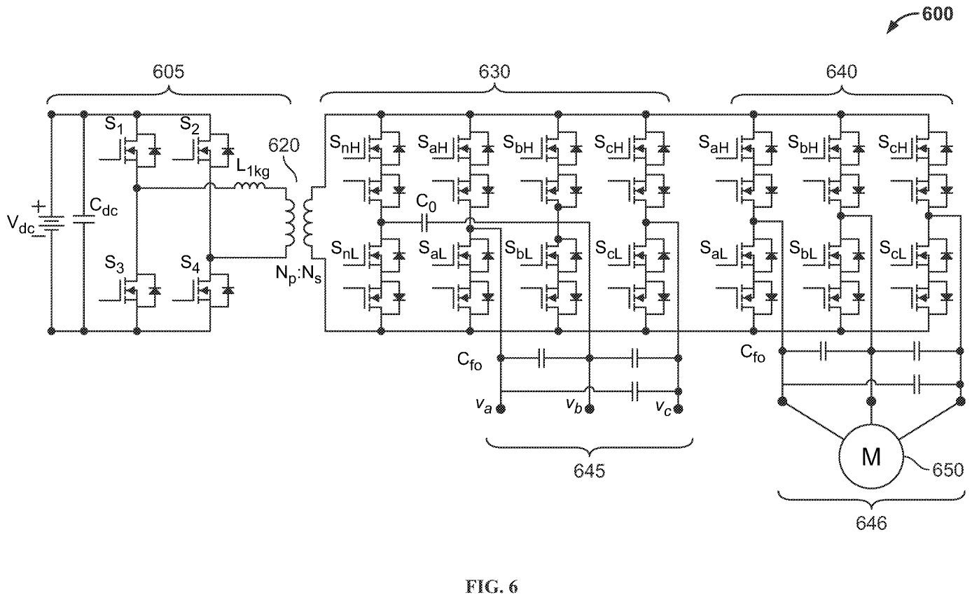

Outside the vehicle, the UMC topology 500 enables all the desired functions, as can be seen in FIG. 5. Unlike for a conventional EV, the UMC system 500 does not require any active components outside the vehicle, simplifying interconnection 510 to a wide variety of sources 505 and loads 520. Further, all services to and from the vehicle can be received or provided using a standard cable 502 and connector, along with standard software and a slow secure communications link (possibly with the cloud) that authorizes energy transactions.

This system can now connect to a 240-V single-phase Level 2 AC service or to a 400-V or 800-V DC fast charger, to charge the battery at a prescribed and safe rate. It can also directly connect to a 480-V AC transformer (without an additional power converter), dramatically reducing the cost of fast charging (because the $100,000 fast charger is eliminated), and can rapidly and broadly deploy EV fast charging capability. The UMC can also deliver energy to the grid for full V2G functionality and can form a microgrid with multiple other UMC-based EVs for resiliency. In vehicle to home (V2H) mode, the EV port can be directly connected to the house electrical system at the meter using a meter-collar and can pick up the whole-house load (typically 200-400-A at 240-V AC) eliminating the need for expensive rewiring and load reprioritization at the home. It can also directly connect to PV panels or other batteries and exchange power with them. Finally, it can also connect to other EVs and exchange power with them-for instance, in an emergency situation when an EV has a discharged battery. By having the UMC provide safe and measured energy ‘transactions’, we are able to commoditize energy into ‘packets’ that can easily be exchanged with a variety of end users and providers, proving very high value.

A second step that further enhances the value of the UMC system comes from integrating at least one of the traction inverters with the UMC. FIG. 6 shows one example, where the UMC converter is rated at 320 kW, feeding the outside grid functions when the vehicle is in ‘stationary’ mode 645. However, when the EV is in traction mode 646, a second traction converter 640 attached to a common UMC high-frequency transformer ‘bus’ 630, now feeds a traction motor 650. Unlike the VSI case, the motor sees low-harmonic sinusoidal waveforms, reducing losses, allowing modularity (e.g., for trucks), and providing flexibility in being able to locate the inverter further away from the motor, and the need to tightly integrate the inverter and the motor. As there is no switching at the motor terminals, EMI is reduced, and bearing currents are eliminated [9]. This also allows the use of induction motors, eliminating the use of rare earth magnets, and still achieving high torque and speed because of an inherent voltage boost capability (which voltage source inverters do not have). It should also be noted that the “grid-connecting” converter 605 and second traction converter 640 never operate together. As a result, there is no thermal impact of adding the second converter stage, and the size impact is minimal (length increase by ~3″). In both cases, the UMC and the original VSI are liquid cooled. The transformer is an advanced coaxial winding transformer (CWT) with nanocrystalline cores for high power density and efficiency (>99.5%) [10] with integrated active cooling and low leakage inductance. Device losses are maintained low through the use of SiC MOSFETs and soft switching.

Vehicle to Everything (V2X) Functionality of UMC-Based EVs In summary, the proposed UMC-based EV achieves at least one objective by retaining the existing 400-VDC battery pack and vehicle platform, while increasing the maximum voltage on the vehicle charging port. This reduces the charging cable current capacity (and cost), while still providing the benefits of 800-VDC faster charging at higher peak power levels to the EV.

As an inverter driving the traction motor, the UMC delivers sinusoidal waveforms on the motor terminals. In a 400-VDC battery system inverter, where the battery voltage reduces to approximately 350-V at full load of 250-kW, the traction motor consumes approximately 600-A. For the UMC, the current drops to 300-A, allowing significant efficiency improvement. By operating an induction motor (IM) at lower currents and higher voltage, can offset efficiency gains from interior permanent magnet (IPM) machines at lower voltage and higher current, while still retaining the benefits of lower cost and high-temperature survivability that the IM provides over the IPM.

In terms of grid connection, the UMC provides current-source functionality with low total harmonic distortion (THD) current waveforms and can connect to a variety of DC and AC sources and loads. The UMC allows battery charging from a variety of AC and DC sources-from 120/240-V 1-phase AC to 208/480-V 3-phase AC, 400-VDC to 800-VDC, and from other sources such as batteries, other EVs or solar panels, at power levels up to 300-kW at current levels that do not exceed 400-A, thus allowing simpler cable management systems. Charging is achieved under software control using a standard single cable and connector. This allows the UMC-EV to charge from existing legacy L2/L3 chargers, but to also directly charge directly from the grid or other raw power sources. Direct charging can reduce the cost of providing the charging needed, and dramatically reduce cost of ownership. Full safety, protection and control are ensured by the vehicle itself without close coordination with other outside equipment.

The UMC-EV provides bidirectional energy flow between the vehicle and the outside world through the same cable and connector.

V2G—the UMC-EV provides advanced grid-forming and support functions, including inertia as needed, damping, and a high level of interoperability. The UMC-EV can also be an integral part of a Virtual Power Plant (VPP) for the grid operator to dispatch.

V2H—the UMC-EV simplifies the connection at the home by essentially powering the entire home, eliminating the need for rewiring the panel and reconnecting and prioritizing loads. The UMC-EV can connect through a meter collar at the incoming service point and support the entire load of a home up to 400 Amperes. Multiple EVs can be connected in parallel to service even higher loads. This can eliminate costs to realize V2H functionality and provide broader coverage. In V2H, the UMC-EV can also connect in parallel with rooftop photovoltaic (PV) panels and home battery inverters, allowing them to feed energy into the system in their normal mode.

V2L (vehicle to load)—the UMC-EV can provide 240-V split phase, or 480-V 3-phase power to power local loads, for example, at a construction site.

V2V (vehicle to vehicle)—the UMC-EV can exchange power with other EVs (including through an existing DC port if allowed). The systems, apparatuses, and methods of this disclosure open up the possibility of selling energy as a commodity.

V2M (vehicle to fractal microgrid)—multiple UMC-EVs can be autonomously interconnected to form a fractal microgrid that can be interconnected and disconnected at will, including to the grid. Such capability allows the formation of resilient microgrids in communities impacted by major events, such as fires and hurricanes.

It is seen that the UMC-EV enables unique functionality, allowing tremendous flexibility in terms of charging from legacy or new infrastructure. It eliminates the need for active power converters on the off-board side, dramatically reducing the cost of implementing fast charging and V2X systems. It provides advanced grid-forming and grid-support functions and can form ad-hoc autonomous microgrids. On the EV itself, the UMC uses wide bandgap SiC semiconductors and soft switching to allow flexible location of the inverter relative to the motor, reduces EMI and high-frequency losses, and eliminates the need to develop an 800-V vehicle platform at great cost. The UMC-EV architecture provides a pathway to get to scale penetration of EVs without having to build massive fast-charging infrastructure at great cost. It can be speculated that if the IWC was beginning its work today (as opposed to in 1991), we would have a very different architecture for EV-grid interface. The UMC-EV provides a solution that achieves all key objectives, while still providing a pathway from where we are today to where we want to go.

### Example Embodiments

In one embodiment, a system is for using an electric vehicle battery as a power source to a load outside of an electric vehicle. The system includes a high frequency transformer assembly 100 connected to the electric vehicle battery 105 and changing an original output power transmission of the EV battery to a different power level transmission. A three phase DC to AC converter circuit 115A, 115B is connected to the transformer assembly 100 and receives the different power level transmission to provide power to a load apparatus either on the electric vehicle, such as a traction motor 120A, 120B or outside the electric vehicle to other loads 130. In some embodiments, the converter circuit is a bi-directional converter circuit, including a three phase DC to AC converter circuit 300, 600.

The converter circuit comprises at least two ports exhibiting current source characteristics from the transformer assembly. The converter circuit may operate in buck-boost mode. The converter circuit may include a 24″×12″×6″ package for a power density of 300-kW/cu. Ft. In non-limiting embodiments, an interconnect device such as a cable 502 is used for connecting the converter circuit to an outside power source, wherein the interconnect device provides power transmission from a 240-V single-phase Level 2 AC service or from a 400-V or 800-V DC fast charger, to charge the battery at a prescribed rate. In some embodiments, the load apparatus is a power meter collar connected to a building wired for electrical power signal consumption or a photovoltaic panel in bi-directional power transmission with the converter circuit or a traction motor when the electric vehicle is in traction mode. In other embodiments, the system utilizes a traction converter when the electric vehicle is in motion, wherein the traction converter operates as an inverter circuit for AC power transmission to a three phase motor. In some embodiments, when the electric vehicle is moving and the converter circuit is providing power to a load other than the three phase motor operates when the electric vehicle is stationary. The converter circuit is a universal minimal converter comprising a four-quadrant semiconductor switch branch configured with a single module with a semiconductor packaging, wherein the packaging is configured to facilitate the thermal management of the device. The converter circuit provides power transfer cycles with switches, wherein the power transfer cycles comprise at least one high-frequency switching cycle in the case of non-isolated converters, or two equal but inverted half cycles, in the case of isolated HF link converters.

A system for using an electric vehicle battery as a power source to a load outside of an electric vehicle may include a high frequency transformer assembly connected to the electric vehicle battery and changing an original output power transmission of the EV battery to a different power level transmission; a three phase DC to AC converter circuit 605, 630 connected to the transformer assembly and receiving the different power level transmission to provide power to a load apparatus either on the electric vehicle or outside the electric vehicle; and a second traction converter 640 connected to the three phase DC to AC converter circuit 605, 630 and further connected to at least one traction motor 650 on the electric vehicle. The three phase DC to AC converter circuit is operable during stationary modes 645 of the electric vehicle. The second traction converter is operable during traction mode 646 of the electric vehicle.

The following references correspond to the bracketed numbers in the text herein and each is incorporated by reference as if set forth in full in this disclosure.

### References

[1] K. W. Klontz, D. M. Divan and D. W. Novotny, “An actively cooled 120 kW coaxial winding transformer for fast charging electric vehicles,” in IEEE Transactions on Industry Applications, vol. 31, no. 6, pp. 1257-1263, Nov.-Dec. 1995.
[2] U.S. Department of Energy. (2023, January 9). FOTW #1272, January 9, 2023: Electric vehicle battery pack costs in 2022 are nearly 90% lower than in 2008, according to DOE estimates. Energy. gov. Retrieved from https://www.energy.gov/eere/vehicles/articles/fotw-1272-january-9-2023-electric-vehicle-battery-pack-costs-2022-are-nearly.
[3] U.S. Department of Energy. (2023, February 15). Fact Sheet: Biden-Harris Administration Announces New Standards and Major Progress for a Made-in-America National Network of Electric Vehicle Chargers. The White House. Retrieved from https://www.whitehouse.gov/briefing-room/statements-releases/2023/02/15/fact-sheet-biden-harris-administration-announces-new-standards-and-major-progress-for-a-made-in-america-national-network-of-electric-vehicle-chargers/.
[4] International Energy Agency. (2023, May). Global EV Outlook 2023. IEA. Retrieved from https://www.iea.org/reports/global-ev-outlook-2023.
[5] M. J. Coren. (2023, Feb. 7). Electric vehicles can now power your home for three days. The Washington Post. Retrieved from https://www.washingtonpost.com/climate-environment/2023/02/07/ev-battery-power-your-home/.
[6] SPAN. (2023). SPAN Panel. Retrieved from https://www.span.io/panel.
[7] Ford Motor Company. (2023). Intelligent Backup Power. Retrieved from https://www.ford.com/trucks/f150/f150-lightning/features/intelligent-backup-power/.
[8] D. Divan, R. P. Kandula and M. J. Mauger, “The Case for Soft Switching in Four-Quadrant Power Converters,” in IEEE Journal of Emerging and Selected Topics in Power Electronics, vol. 9, no. 6, pp. 6545-6560, Dec. 2021.
[9] R. Amorim Torres, H. Dai, W. Lee, B. Sarlioglu and T. Jahns, “Current-Source Inverter Integrated Motor Drives Using Dual-Gate Four-Quadrant Wide-Bandgap Power Switches,” in IEEE Transactions on Industry Applications, vol. 57, no. 5, pp. 5183-5198, Sept.-Oct. 2021.
[10] M. S. Rauls, D. W. Novotny and D. M. Divan, “Design considerations for high-frequency coaxial winding power transformers,” in IEEE Transactions on Industry Applications, vol. 29, no. 2, pp. 375-381, March-April 1993.

1. A system for using an electric vehicle battery as a power source to a load outside of an electric vehicle, the system comprising:
a high frequency transformer assembly connected to the electric vehicle battery and changing an original output power transmission of the EV battery to a different power level transmission;
a three phase DC to AC converter circuit connected to the transformer assembly and receiving the different power level transmission to provide power to a load apparatus either on the electric vehicle or outside the electric vehicle.

2. The system of claim 1, wherein the converter circuit is a bi-directional converter circuit.

3. The system of claim 2, wherein the converter circuit comprises at least two ports exhibiting current source characteristics from the transformer assembly.

4. The system of claim 1, wherein the converter circuit operates in buck-boost mode.

5. The system of claim 1, wherein the converter circuit comprises a 24″×1 2″×6″ package for a power density of 300-kW/cu. Ft.

6. The system of claim 1, further comprising an interconnect device connecting the converter circuit to an outside power source, wherein the interconnect device provides power transmission from a 240-V single-phase Level 2 AC service or from a 400-V or 800-V DC fast charger, to charge the battery at a prescribed rate.

7. The system of claim 1, wherein the load apparatus is a power meter collar connected to a building wired for electrical power signal consumption.

8. The system of claim 1, wherein the load apparatus is a photovoltaic panel in bi-directional power transmission with the converter circuit.

9. The system of claim 1, further comprising a traction converter to provide power to a traction motor when the electric vehicle is in traction mode.

10. The system of claim 9, wherein the traction converter operates as an inverter circuit for AC power transmission to a three phase motor.

11. The system of claim 10, wherein the traction converter operates when the electric vehicle is moving and the converter circuit providing power to a load other than the three phase motor operates when the electric vehicle is stationary.

12. The system of claim 1, wherein the converter circuit is a universal minimal converter comprising a four-quadrant semiconductor switch branch configured with a single module with a semiconductor packaging, wherein the packaging is configured to facilitate the thermal management of the device.

13. The system of claim 12, wherein the converter circuit provides power transfer cycles with switches, wherein the power transfer cycles comprise at least one high-frequency switching cycle in the case of non-isolated converters, or two equal but inverted half cycles, in the case of isolated HF link converters.

14. A system for using an electric vehicle battery as a power source to a load outside of an electric vehicle, the system comprising:
a high frequency transformer assembly connected to the electric vehicle battery and changing an original output power transmission of the EV battery to a different power level transmission;
a three phase DC to AC converter circuit connected to the transformer assembly and receiving the different power level transmission to provide power to a load apparatus either on the electric vehicle or outside the electric vehicle;
a second traction converter connected to the three phase DC to AC converter circuit and further connected to at least one traction motor on the electric vehicle.

15. The system of claim 14, wherein the three phase DC to AC converter circuit is operable during stationary modes of the electric vehicle.

16. The system of claim 14, wherein the second traction converter is operable during traction mode of the electric vehicle.

17. The system of claim 14, wherein the converter circuit is a bi-directional converter circuit.

18. The system of claim 17, wherein the converter circuit comprises at least two ports exhibiting current source characteristics from the transformer assembly.

19. The system of claim 14, wherein the converter circuit operates in buck-boost mode.

20. The system of claim 14, wherein the traction converter operates when the electric vehicle is moving and the converter circuit providing power to a load other than the three phase motor operates when the electric vehicle is stationary.
